(19) United States
(12) Patent Application Publication
(10) Pub. No.: US 2006/0140095 A1
(43) Pub. Date: Jun. 29, 2006

(54) Optical disk apparatus

(76) Inventors: Yusuke Kazami, Fujisawa (JP); Kazunori Uemura, Ebina (JP); Kouji Minabe, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/313,823

(22) Filed: Dec. 22, 2005

(30) Foreign Application Priority Data
Dec. 24, 2004 (JP) 2004-372539

(51) Int. Cl. G11B 5/09

(52) U.S. Cl. 369/59.1; 369/47.1

(57) ABSTRACT

An optical disk apparatus includes an intermittent operation unit that causes a recording/standby memory device to accumulate an audio signal and video signal to be recorded and to intermittently read the signals, and causes a spindle motor control circuit and optical head control circuit to be intermittently actuated in response to the signals so that the signals can be recorded on an optical disk, a learning operation unit that obtains control values suited to the spindle motor control circuit and optical head control circuit, and a unit that judges about the necessity of the learning operation according to a temperature change and a surface condition of the optical disk.

The present application claims priority from Japanese application JP2004-372539 filed on Dec. 24, 2004, the content of which is hereby incorporated by reference into this application.

### BACKGROUND OF THE INVENTION

The present invention relates to optical disk apparatus that make intermittent recording operation and that can make learning operation in association with the recording operation, and particularly to the technology for reducing power consumption by stopping unnecessary operations when the recording is started.

In recent years, we often see recording/reproducing apparatus that use large-capacity optical disks as recording media. The typical examples of these apparatus are video cameras and video recorders. In the optical disk apparatus that are used in these video cameras, it is important subject to reduce the power consumption. Particularly, the portable apparatus such as video cameras are generally driven by batteries. In order that the video camera can be operated for a long time, it is important to reduce the power consumption.

Thus, a method for reducing the power consumption has been proposed in which the disk is intermittently recorded or reproduced. That is, this method employs the fact that the rate of recording on the optical disk is much faster than that of encoding video and sound, and thus this method uses a buffer memory capable of temporarily storing video/sound data. More specifically, the optical disk apparatus is stopped in its recording operation and held in a standby mode until the buffer memory accumulates a first predetermined amount of data. When the data accumulated in the buffer memory reaches the first predetermined amount or above, the optical disk apparatus is made in an operating mode to start recording and to record the data of the buffer memory on the disk until the data of the buffer memory decreases down to a second predetermined amount or below. When the second predetermined amount is reached, the apparatus is stopped in its recording operation and held in the standby mode, so that the video/sound data can be intermittently recorded on the optical disk. Therefore, in the period in which the operation of recording data on the optical disk is suspended (hereinafter, called the standby mode), the operation of, for example, a spindle motor, spindle motor control circuit, optical head portion and optical head control circuit is stopped so that the power to the optical disk apparatus can be reduced. Although the standby mode is specified as above, the period in which the apparatus is being operated to record data on the optical disk is called the operating mode.

On the other hand, the optical disk apparatus is easily affected by the temperature distribution and the surface condition of the optical disk, and thus it is not simple to perform suitable control for the recording and reproduction. Particularly, the output power of a laser that is used to record data on the optical disk is apt to be influenced by the temperature change. Therefore, the so-called learning operation has been proposed in which the light beam of the laser with its output changed is irradiated on a particular area of the optical disk to make the test of recording and reproduction before the actual recording, thereby finding the conditions at which the data error rate of the reproduced signal is appropriate.

In addition, a technique for making the learning operation together with the above intermittent operation is proposed. In this technique, when the user orders the apparatus to start recording, the intermittent operation and the learning operation are started at the same time. In other words, since the learning processing takes about 5 to 10 seconds, the intermittent operation is started and at the same time the learning operation is also started so that the leaning operation can be finished until the data accumulated in the buffer memory reaches the first predetermined amount, or before the recording on the optical disk is started. An example of this operation will be described below. We now consider that the power supply to the optical disk apparatus is kept in the on-state in which the power for recording is not consumed. When the user enters a start recording request, the optical disk apparatus is shifted from the state in which the intermittent operation is not made yet (hereinafter, called the stopped mode) to the intermittent operation mode (or intermittent operation). Immediately after this intermittent operation is started, the apparatus is made in the operating mode by operating elements of, for example, a spindle motor, a spindle motor control circuit, an optical head portion and an optical head control circuit, and in this operating mode the learning operation is performed. In addition, before the learning operation is started, the current temperature is measured by a temperature sensor for monitoring the temperature change, and compared to the temperature previously measured at the past learning operation time. In this case, only when the temperature difference is judged to be larger than a predetermined value, the learning operation is performed. Thus, the number of times that the learning operation is performed can be restricted depending on this judgment. (See, for example, JP-A-2002-74694).

In the technique disclosed in the document of JP-A-2002-74694, when the optical disk apparatus is shifted from the stopped mode to the intermittent operation, and when the current temperature is almost not changed as compared to that previously measured at the past learning operation time so that the learning operation is not necessary, the learning operation is not performed, but in this case, there is the following problem. When the intermittent operation is started, the spindle motor, spindle motor control circuit, optical head portion and optical head control circuit are actuated so that the apparatus is made in the operating mode, but after the end of the judgment about the necessity of the learning operation, the operating mode is maintained until the amount of data accumulated in the buffer memory reaches a first predetermined value, thus unnecessary power being consumed.

In addition, even when the learning operation is performed because of a temperature difference between the current temperature and the temperature previously measured at the past learning operation time, the intermittent operation is started and the elements of spindle motor, spindle motor control circuit, optical head portion and optical head control circuit are actuated so that the apparatus is made in the operating mode, but even after the end of the learning operation following the judgment about the necessity of the learning operation, the operating mode is maintained until the amount of data accumulated in the buffer memory reaches the first predetermined amount so that the recording operation is started, thus unnecessary power being consumed. Here, particularly when the recording time necessary for each round of shooting is short as in the use of a video camera, the unnecessary power consumption in the operating mode continued from the start of the intermittent operation occupies a very large portion of the whole power consumed over all the recording times, thus causing a problem.

### SUMMARY OF THE INVENTION

Accordingly, it is an objective of the invention to provide an optical disk apparatus in which, in the case when the apparatus is shifted from the stopped mode to the intermittent operation at the time of starting the recording operation, when the standby mode is judged not to be necessary, the apparatus is made in the standby mode immediately after the end of the judgment about the necessity of the learning operation, while when the learning operation is judged to be necessary, the apparatus is made in the standby mode after the end of the learning operation, so that the power consumption can be reduced.

In order to solve the above problem, the present invention employs the following means.

According to the first aspect of the invention, there is provided an optical disk apparatus having a drive/control device that drives and controls a spindle motor and/or optical head portion, an intermittent operation unit that causes the drive/control device to intermittently operate to record on an optical disk, and a learning operation unit that judges about the necessity of a learning operation for acquiring a predetermined control value to the drive/control device under an arbitrary condition and that makes the learning operation according the result of the judgment. When a predetermined operation is made to start recording so that the optical disk apparatus can be transiently shifted to an intermittent operation, the drive/control device is operated so that the optical disk apparatus can be made in an operating mode in which the judgment is made about the necessity of the learning operation. If the learning operation is judged not to be necessary, the optical disk apparatus is shifted to a standby mode in which the drive/control device can be stopped from its operation after the end of the judgment about the necessity of the learning operation. Thus, if the learning operation is not necessary at the start of the intermittent operation, the optical disk apparatus is changed from the operating mode to the standby mode after the end of the judgment about the necessity of the learning operation. Thus, the power consumption can be reduced because unnecessary operating mode can be avoided.

According to the second aspect of the invention, there is provided an optical disk apparatus having a drive/control device that drives and controls a spindle motor and/or optical head portion, an intermittent operation unit that causes the drive/control device to intermittently operate to record on an optical disk, and a learning operation unit that judges about the necessity of a learning operation for acquiring a predetermined control value to the drive/control device under an arbitrary condition and that makes the learning operation according the result of the judgment. When a predetermined operation is made to start recording so that the optical disk apparatus can be transiently shifted to the intermittent operation, the drive/control device is operated so that the optical disk apparatus can be made in an operating mode in which the judgment is made about the necessity of the learning operation. If the learning operation is judged to be necessary, the optical disk apparatus is shifted to a standby mode in which the drive/control device is stopped from its operation after the end of the learning operation. Therefore, even if the learning operation is necessary when the intermittent operation is started, the optical disk apparatus is made from the operating mode to the standby mode after the end of the learning operation following the judgment about the necessity of the learning operation. Thus, the power consumption can be reduced because there is no unnecessary operating mode.

According to the third aspect of the invention, there is provided an optical disk apparatus having a recording/standby memory device for accumulating a signal to be recorded, a signal processing circuit for processing the signal read from the recording/standby memory device so as to be recorded on an optical disk, a drive/control device that drives and controls a spindle motor and/or optical head portion, an intermittent operation unit that causes the drive/control device to intermittently operate so that the signal can be recorded on the optical disk, and a learning operation unit that judges about the necessity of the learning operation for acquiring a predetermined control value to the drive/control device under an arbitrary condition and that makes the learning operation according to the result of the judgment. When a certain operation is performed to start recording so that the optical disk apparatus is transiently shifted to the intermittent operation, the drive/control device is operated so that the optical disk apparatus can be made in an operating mode in which the judgment is made about the necessity of the learning operation. If the learning operation is judged not to be necessary, a signal to be recorded that has been accumulated in the recording/standby memory device until the end of the judgment about the necessity of the learning operation is recorded on the optical disk, and then the optical disk apparatus is shifted to the standby mode in which the drive/control device can be stopped from its operation. Therefore, if the learning operation is not necessary when the intermittent operation is started, the signal to be recorded that has been accumulated until the end of the judging operation about the necessity of the learning operation is recorded on the optical disk so that the amount of data within the recording/standby memory device can be decreased, and then the optical disk apparatus is changed from the operating mode to the standby mode. Therefore, the unnecessary operating mode can be stopped, and thus the period of the standby mode that continues up to the next recording operation can be extended, leading to the reduction of the power consumption because there is no unnecessary operating mode.

According to the fourth aspect of the invention, there is provided an optical disk apparatus having a recording/standby memory device for accumulating a signal to be recorded, a signal processing circuit for processing the signal read from the recording/standby memory device so as to be recorded on an optical disk, a drive/control device that drives and controls a spindle motor and/or optical head portion, an intermittent operation unit that causes the drive/control device to intermittently operate so that the signal can be recorded on the optical disk, and a learning operation unit that judges about the necessity of the learning operation for acquiring a predetermined control value to the drive/control device under an arbitrary condition and that makes the learning operation according to the result of the judgment. Immediately after a certain operation is performed to start recording so that the optical disk apparatus is transiently shifted to the intermittent operation, the drive/control device is operated so that the optical disk apparatus can be made in an operating mode in which the judgment is made about the necessity of the learning operation. If the learning operation is judged to be necessary, a signal to be recorded that has been accumulated in the recording/standby memory device until the end of the learning operation is recorded on the optical disk, and the optical disk apparatus is shifted to a standby mode in which the drive/control device is stopped from its operation. Therefore, when the learning operation is necessary at the start of intermittent operation, the signal to be recorded that has been accumulated in the recording/standby memory device until the end of the learning operation is recorded on the optical disk so that the amount of data within the recording/standby memory device can be decreased, and then the optical disk apparatus is shifted from the operating mode to the standby mode. Accordingly, there is no unnecessary operating mode, and the period of the standby mode that continues up to the next recording operation can be extended. Thus, the power consumption can be reduced because there is no unnecessary operating mode.

According to the fifth aspect of the invention, there is provided an optical disk apparatus having a drive/control device that drives and controls a spindle motor and/or optical head portion, an intermittent operation unit that causes the drive/control device to intermittently operate to record on an optical disk, and a learning operation unit that judges about the necessity of a learning operation for acquiring a predetermined control value to the drive/control device under a temperature change and that makes the learning operation according to the result of the judgment. When a certain operation is made to start recording so that the optical disk apparatus is transiently shifted to an intermittent operation, the optical disk apparatus is made in a standby mode in which the drive/control means is stopped from its operation. In this standby mode, the judgment is made about the necessity of the learning operation from the information of the temperature change. If the learning operation is judged not to be necessary, the standby mode is maintained. Therefore, if the temperature change does not need the learning operation, the optical disk apparatus is not made in the operating mode but maintained in the standby mode when the intermittent operation is started, and thus the power consumption can be further reduced.

According to the sixth aspect of the invention, there is provided an optical disk apparatus having a drive/control device that drives and controls a spindle motor and/or optical head portion, an intermittent operation unit that causes the drive/control device to intermittently operate to record on an optical disk, and a learning operation unit that judges about the necessity of a learning operation for acquiring a predetermined control value to the drive/control device under a temperature change and that makes the learning operation according to the result of the judgment. When a certain operation is made to start recording so that the optical disk apparatus is transiently shifted to an intermittent operation, the optical disk apparatus is made in a standby mode in which the drive/control means is stopped. In this standby mode, the judgment is made about the necessity of the learning operation from the information of the temperature change. If the learning operation is judged to be necessary, the optical disk apparatus is made in the operating mode in which the drive/control device is operated, and then the optical disk apparatus is shifted to the standby mode in which the drive/control device is stopped from its operation after the end of the learning operation. Therefore, if the temperature change needs the learning operation, the operating mode is not required for the judging operation about the necessity of the learning operation. Thus, unnecessary operating mode can be minimized, and hence the power consumption can be further reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the construction of an embodiment 1 of a video disk apparatus according to the invention.

FIG. 2 is a timing chart of the operation of a drive controller 7 in the embodiment 1.

FIG. 3 is a flowchart of the intermittent operation in the embodiment 1.

FIG. 4 is a timing chart of the operation of the drive controller 7 in an embodiment 2.

FIG. 5 is a timing chart of the operation of the drive controller 7 in a third embodiment.

### DETAILED DESCRIPTION OF THE EMBODIMENTS

The embodiments of this invention will be described with reference to the accompanying drawings.

### Embodiment 1

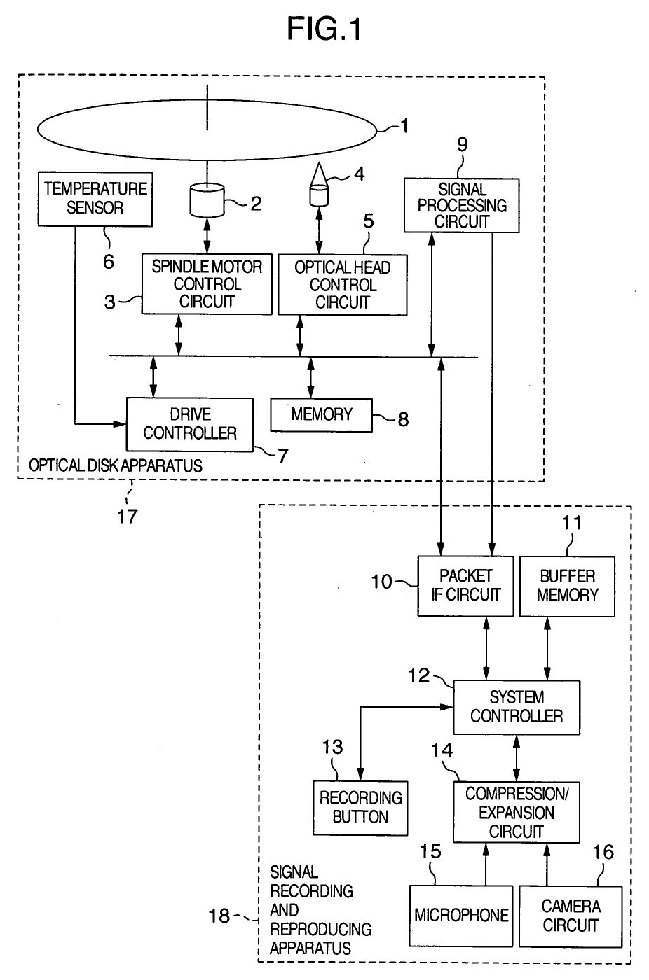

FIG. 1 is a block diagram showing the construction of the embodiment 1 of a video camera to which the optical disk apparatus of the invention is applied. Referring to FIG. 1, there are shown an optical disk 1, a spindle motor 2, a spindle motor control circuit 3, an optical head portion 4, an optical head control circuit 5, a temperature sensor 6, a drive controller 7, a memory 8, signal processing circuit 9, a packet interface (IF) circuit 10, a buffer memory 11, a system controller 12, a recording button 13, a compression/expansion circuit 14, a microphone 15, and a camera circuit 16. The elements 1 through 9 constitute an optical disk apparatus 17, and the elements 10 through 16 constitute a signal recording and reproducing apparatus 18.

The spindle motor 2 is controlled by the spindle motor control circuit 3 so that the optical disk 1 can be rotated at a predetermined rotational speed. The optical head portion 4 is constructed to be movable in the focusing and tracking directions under the control of the optical head control circuit 5. The signal processing circuit 9 is constructed to process the digital data to be recorded on the optical disk 1 so that it can be converted into recording data suitable for the characteristics of the optical disk 1, and to supply the recording data to the optical head portion 4 by which it can be recorded on the optical disk 1.

On the other hand, the compression/expansion circuit 14 compresses data of the video signal of an object photographed by the camera circuit 16 and the audio signal produced by the microphone 15. In this data compression, the signal redundancy and the characteristics of human visual and auditory senses are utilized so that the amount of the data to be stored on the optical disk 1 can be reduced. In addition, the compression/expansion circuit 14 expands the compressed data at the time of reproduction so that it can be restored to the original video and audio signals.

The intermittent operation and learning operation using the buffer memory 11 will be described below. In the stopped mode in which only the power supply is turned on, the spindle motor 2, spindle motor control circuit 3, optical head portion 4 and optical head control circuit 5 are not operated, and thus a low power consumption is maintained. When the recording button 13 connected to the system controller 12 is pushed in this stopped mode, the system controller 12 issues a startup command to the drive controller 7 through the packet IF circuit 10. After receiving the startup command from the system controller 12, the drive controller 7 immediately drives the spindle motor control circuit 3 and optical head control circuit 5 to operate. Thus, the spindle motor 2 and optical head portion 4 are controlled so that the optical disk apparatus 17 can be transiently shifted from the stopped mode to the operating mode. At this time, the optical head portion 4 irradiates a laser beam on the surface of the optical disk 1 and acquires the condition (contamination) of the surface, and the temperature sensor 6 measures and acquires the current temperature. In addition, the drive controller 7 judges whether the learning operation is necessary according to the acquired surface condition of optical disk 1 and according to the temperature difference between the acquired current temperature and the temperature previously measured at the end of the past learning operation and stored in the memory 8. When the drive controller 7 judges the learning operation not to be necessary, it stops the operation of the spindle motor control circuit 3, optical head control circuit 5, spindle motor 2 and optical head portion 4 immediately after the end of the judging operation. Thus, the optical disk apparatus 17 is shifted to the standby mode so that the power consumption can be reduced. If the learning operation is judged to be necessary, the drive controller 7 maintains the operating mode, and performs the learning operation. After the end of the learning operation, the drive controller 7 stops the operation of the spindle motor control circuit 3, optical head control circuit 5, spindle motor 2 and optical head portion 4. Thus, the optical disk apparatus is shifted to the standby mode so that the power consumption can be reduced. Although the operation of the spindle motor control circuit 3, optical head control circuit 5, spindle motor 2 and optical head portion 4 is stopped in each of the stopped mode and standby mode, the standby mode in this embodiment indicates a halt mode as a part of the intermittent operation that is made at the recording time.

As described above, when the recording button 13 is pushed, the system controller 12 issues the startup command to the drive controller 7, causing it to make a sequence of operations of the judgment about the necessity of the learning operation. At the end of the judgment, it causes the optical disk apparatus 17 to be shifted to the standby mode. At the same time, the system controller 12 controls the compression/expansion circuit 14 to receive the video signal produced from the camera circuit 16 and the audio signal produced from the microphone 15, and it controls the buffer memory 11 to accumulate the compressed digital data from the compression/expansion circuit 14. Thereafter, when the amount of the digital data accumulated in the buffer memory 11 exceeds a predetermined value v1 that is previously set, the system controller 12 controls the digital data to be sequentially read out from the buffer memory 11 and to be supplied through the packet IF circuit 10 to the optical disk apparatus 17. In addition, the system controller 12 issues a command to the drive controller 7 through the packet IF circuit 10 so that the optical disk apparatus 17 can be again shifted from the standby mode to the operating mode. Thus, the digital data fed from the packet IF circuit 10 is converted into the recording data by the signal processing circuit 9 and recorded on the optical disk 1. Then, when the amount of the digital data accumulated in the buffer memory 11 decreases down to a predetermined value v2 that is previously set, the system controller 12 stops the digital data from being supplied and issues a standby shift command to the drive controller 7 so that the optical disk apparatus 17 can be shifted to the standby mode. Subsequently, when the amount of the digital data accumulated in the buffer memory 11 exceeds the predetermined value v1, the optical disk apparatus is shifted to the operating mode in which the recording data is recorded, and when the amount decreases to the predetermined value v2 as the recording advances, the apparatus is made in the standby mode, thus intermittent operation being performed. The above intermittent operation is repeated until the user again pushes the recording button 13.

In the transient intervals in which the optical disk apparatus 17 is shifted from the operating mode to the standby mode or from the standby mode to the operating mode, a sound emitted due to the rotation of optical disk 1 by the spindle motor 2 could be picked up by the microphone 15. In order to solve this problem, only the spindle motor control circuit 3 may be operated to rotate the spindle motor 2 in the standby mode. Thus, since the rise time of the spindle motor 2 becomes short when the optical disk apparatus is transiently shifted to the operating mode, the predetermine value v1 can be increased, and thus the data accumulating time can be extended. As a result, the ratio of the standby period to the operating period of the intermittent operation is increased, and thus it is possible to increase the effect of further reducing the power consumption.

Thus, the operation of the spindle motor control circuit, optical head control circuit 5, spindle motor 2 and optical head portion 4 is stopped immediately after the end of the judgment about the necessity of the learning operation when the learning operation is not necessary. It is also stopped after the end of the learning operation when the learning operation is necessary. Therefore, since the apparatus is made in the standby mode until the amount of digital data accumulated in the buffer memory 11 exceeds the predetermined value v1, unnecessary power can be prevented from being consumed, and thus the power consumption can be further reduced.

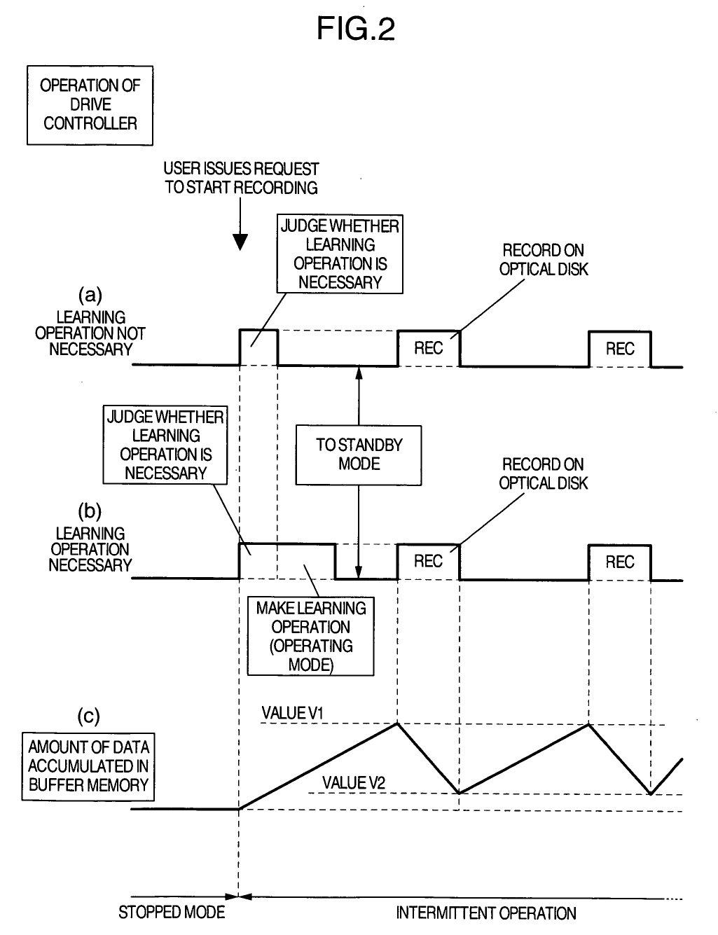

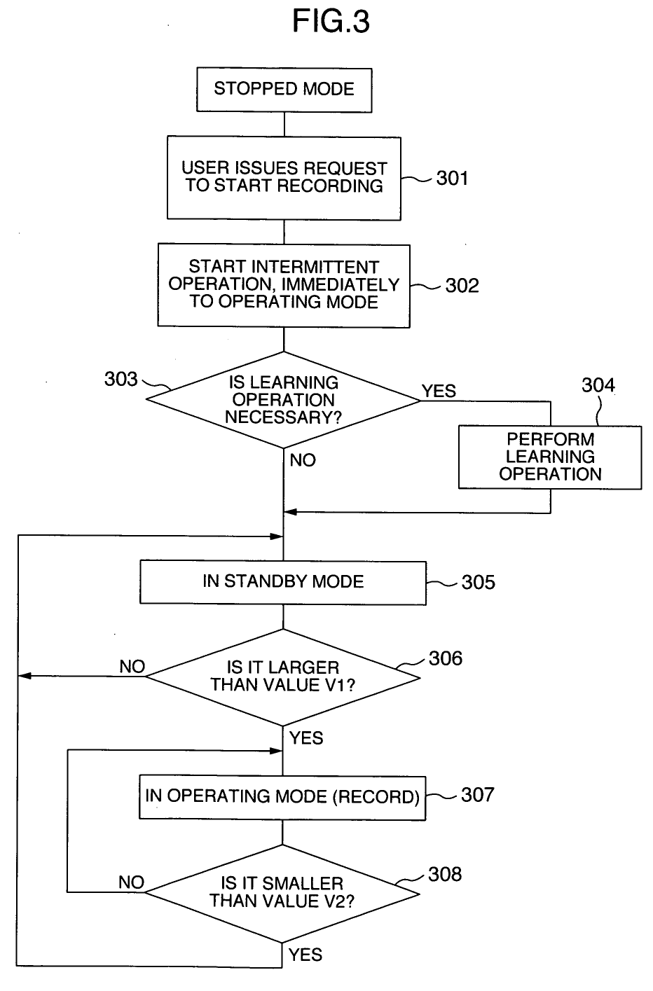

With reference to FIGS. 2 and 3, description will be made of the details of the operation of the drive controller 7 in the case when the user orders to start recording so that the optical disk apparatus can be shifted from the stopped mode to the intermittent mode. FIG. 2 is a timing chart of the operation of the drive controller 7 according to the invention. In FIG. 2, a waveform (a) shows the timing of the case in which the learning operation is not necessary, a waveform (b) the timing of the case in which the learning operation is necessary, and a waveform (c) the change of the amount of the digital data accumulated in the buffer memory 11.

The operation of drive controller 7 in the case where the learning operation is not necessary will be described with reference to the waveforms (a) and (c) of FIG. 2. In the stopped mode, when the user pushes the recording button 13 to request to start recording, the spindle motor control circuit 3 and optical head control circuit 5 are actuated to control the spindle motor 2 and optical head portion 4 so that the optical disk apparatus can be made in the operating mode in which judgment is made of whether the learning operation is necessary. At this time, the optical head portion 4 irradiates a laser beam on the surface of the optical disk 1 to acquire the surface condition, and the temperature sensor 6 measures the current temperature to acquire the current temperature. From the acquired surface condition and current temperature, the judgment is made of whether the surface condition of optical disk 1 needs the learning operation or whether the current temperature has a temperature difference that needs the learning operation when compared to the temperature previously measured at the end of the past learning operation and stored in the memory 8. Here, since the learning operation is not necessary, the drive controller stops the operation of the spindle motor control circuit 3, optical head control circuit 5, spindle motor 2 and optical head portion 4 immediately after the end of the judgment about the necessity of the learning operation so that the optical disk apparatus can be made in the standby mode. On the other hand, when the amount of the digital data of the video and audio signals accumulated in the buffer memory 11 just from the recording start time increases to exceed the predetermined value v1 as shown by the waveform (c) of FIG. 2, the spindle motor control circuit 3 and optical head control circuit 5 are actuated to control the spindle motor 2 and optical head portion 4 so that the optical disk apparatus can be made in the operating mode. At this time, the digital data is sequentially read out from the buffer memory 11, and recorded as the recording data on the optical disk 1. Here, since the rate of reading out the digital data is larger than that of accumulating it, the amount of the data within the buffer memory 11 decreases. When the amount decreases down to the predetermined value v2 as shown by the waveform (c) of FIG. 2, the operation of the spindle motor control circuit 3, optical head control circuit 5, spindle motor 2 and optical head portion 4 is stopped so that the optical disk apparatus can be made in the standby mode. At this time, since the data is not read out from the buffer memory 11, the data is increasingly accumulated. When the amount of the data reaches the predetermined value v1, the optical disk apparatus is again made in the operating mode, in which the recording operation is resumed. Thereafter, the above intermittent operation is repeated.

The operation of drive controller 7 in the case where the learning operation is necessary will be described with reference to the waveforms (b) and (c) of FIG. 2. In the stopped mode, when the user pushes the recording button 13 to request to start recording, the spindle motor control circuit 3 and optical head control circuit 5 are actuated to control the spindle motor 2 and optical head portion 4 so that the optical disk apparatus can be made in the operating mode, in which the judgment is made of whether the learning operation is necessary. The optical head portion 4 irradiates the laser beam on the surface of the optical disk 1 to acquire the surface condition, and the temperature sensor 6 measures the current temperature to acquire the current temperature. From the acquired surface condition and current temperature, the judgment is made of whether the surface condition of optical disk 1 needs the learning operation or whether the current temperature has a temperature difference that needs the learning operation when compared to the temperature previously measured at the end of the past learning operation and stored in the memory 8. Here, since the learning operation is necessary, the operating mode is maintained, and the learning operation is performed. When the learning operation is finished, the operation of the spindle motor control circuit 3, optical head control circuit 5, spindle motor 2 and optical head portion 4 is stopped so that the optical disk apparatus can be made in the standby mode. Then, when the amount of the digital data accumulated in the buffer memory 11 increases to exceed the predetermined value v1 as shown by the waveform (c) of FIG. 2, the spindle motor control circuit 3 and optical head control circuit 5 are actuated to control the spindle motor 2 and optical head portion 4 so that the optical disk apparatus can be made in the operating mode. At this time, the digital data is sequentially read out from the buffer memory 11 and recorded as the recording data on the optical disk 1. Thereafter, the standby mode and the operating mode are repeated to make the intermittent operation as in the operation of drive controller 7 of the case where the learning operation is not necessary.

Thus, when the learning operation is not necessary, the operation of the spindle motor control circuit 3, optical head control circuit 5, spindle motor 2 and optical head portion 4 is stopped immediately after the end of the judgment about the necessity of the learning operation. In addition, when the learning operation is necessary, the operation of the spindle motor control circuit 3, optical head control circuit 5, spindle motor 2 and optical head portion 4 is stopped after the end of the learning operation. Therefore, since the optical disk apparatus is maintained in the standby mode until the amount of the digital data accumulated in the buffer memory 11 exceeds the predetermined value v1, unnecessary power can be prevented from being consumed, and thus the power consumption can be further reduced.

The flow of processes at the recording start time will be described with reference to FIG. 3. FIG. 3 is a flowchart of the intermittent operation according to the invention. First in the stopped mode, the operation of the spindle motor control circuit 3, optical head control circuit 5, spindle motor 2 and optical head portion 4 is stopped. When the user enters the request to start recording in step 301, the system controller 12 issues the startup command to make the intermittent operation in step 302. Thus, the drive controller 7 causes the optical disk apparatus 17 to be shifted to the operating mode. Then, in step 303, judgment is made of whether the learning operation is necessary. At this time, the drive controller 7 controls the optical head portion 4 to irradiate the laser beam on the surface of the optical disk 1 and to acquire the surface condition, and controls the temperature sensor 6 to measure the current temperature and to acquire the current temperature. From the acquired surface condition and current temperature, the drive controller 7 judges whether the surface condition of optical disk 1 needs the learning operation or whether the current temperature has a temperature difference that needs the learning operation when compared to the temperature previously measured at the end of the past judgment about the necessity of the learning operation and stored in the memory 8. If the learning operation is judged to be not necessary, the optical disk apparatus 17 is made in the standby mode in step 305 immediately after the judgment about the necessity of the learning operation. If the learning operation is judged to be necessary in step 303, the operating mode is continued, and in step 304 the learning operation is performed. After the end of the learning operation, the program goes to step 305, where the optical disk apparatus 7 is made in the standby mode.

Thus, when the learning operation is not necessary, the standby mode is brought about immediately after the end of the judgment about the necessity of the learning operation. In addition, when the learning operation is necessary, the standby mode is brought about after the end of the learning operation. Therefore, since the standby mode is maintained until the amount of the digital data accumulated in the buffer memory 11 exceeds the predetermined value v1, unnecessary power can be prevented from being consumed, and thus the power consumption can be further reduced.

On the other hand, the buffer memory 11 is accumulating the digital data during the period from the recording start request of step 301 to the step 305. In step 306, judgment is made of whether the amount of the digital data accumulated exceeds the predetermined value v1. If it exceeds, the program goes to step 307, where the optical disk apparatus 17 is made in the operating mode and the digital data is recorded on the optical disk 1. If it does not exceed the predetermined value v1 in step 306, the program goes back to step 305, where the apparatus waits for the buffer memory to accumulate the digital data. If the recording operation is started in step 307, the amount of data in the buffer memory 11 decreases. In step 308, judgment is made of whether the amount of data accumulated in the buffer memory 11 has decreased down to the predetermined value v2 or below. If it has decreased down to the value v2 or below, the program goes back to step 305, where the standby mode is brought about. If the amount of the digital data is larger than the predetermined value v2 in step 308, the program goes back to step 307, where the recording is continued. Thereafter, similarly the standby mode and operating mode are repeated to make the intermittent operation. In addition, if the recording button 13 is pushed during the intermittent operation, the optical disk apparatus is made in the operating mode, and the digital data accumulated in the buffer memory 11 is recorded on the optical disk 1 and then the optical disk apparatus is made in the stopped mode.

The recording and reproduction of the video signal from the camera circuit in this embodiment have been described as above. The present invention is not limited to the above description, but can be extended to other recording and reproducing apparatus such as a video recorder by substituting, for example, a radio signal receiving circuit for the camera circuit.

### Embodiment 2

The embodiment 2 will be described. The optical disk apparatus 17 and signal recording and reproducing apparatus 18 in the embodiment 2 have the same constructions as those in the embodiment 1, and the recording method using the intermittent operation is the same as in the embodiment 1.

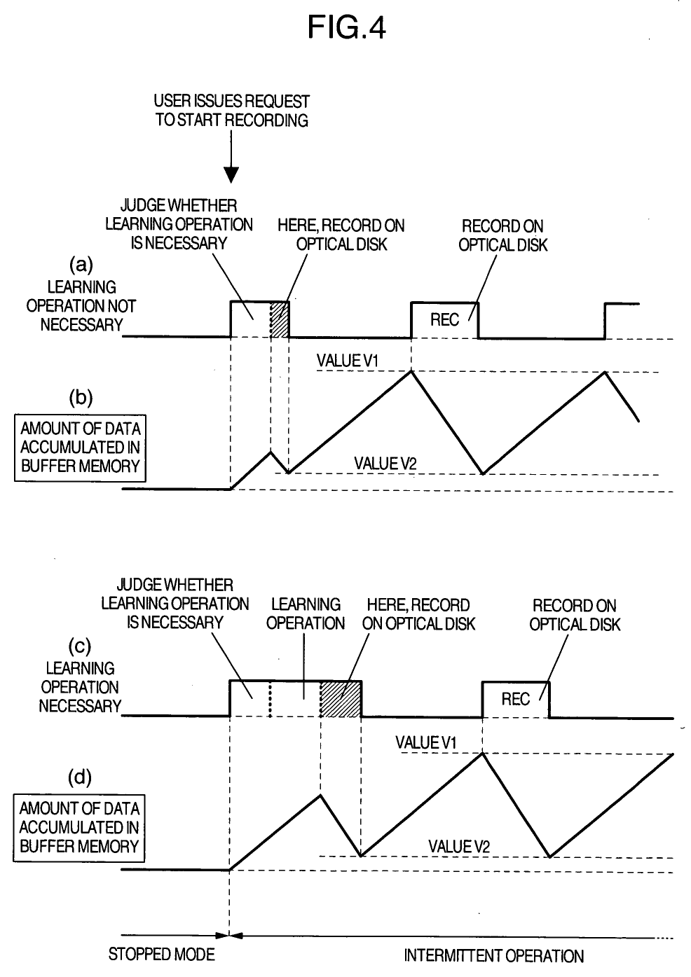

With reference to FIG. 4, description will be made of the detailed operation of the drive controller 7 in the case when the user enters the request to start recording so that the optical disk apparatus 17 can be shifted from the stopped mode to the intermittent operation. FIG. 4 is a timing chart of the operation of drive controller 7 in the embodiment 2 of the invention. In FIG. 4, the waveform (a) shows the timing of the operation of drive controller 7 in the case where the learning operation is not necessary, the waveform (b) the change of the amount of the digital data accumulated in the buffer memory 11 in the case of the waveform (a) of FIG. 4, the waveform (c) the timing of the operation of drive controller 7 in the case where the learning operation is necessary, and the waveform (d) the change of the amount of the digital data accumulated in the buffer memory 11 in the case of the waveform (c) of FIG. 4.

The operation of drive controller 7 in the case where the learning operation is not necessary will be described with reference to the waveforms (a) and (b) of FIG. 4. When the user pushes the recording button 13 in the stopped mode, a recording start request is issued, and thus the spindle motor control circuit 3 and optical head control circuit 5 are activated to control the spindle motor 2 and optical head portion 4 so that the optical disk apparatus can be made in the operating mode, in which judgment is made of whether the learning operation is necessary. At this time, the optical head portion 4 irradiates a laser beam on the surface of the optical disk to acquire the surface condition, and the temperature sensor 6 measures the current temperature to acquire the current temperature. From the acquired surface condition and current temperature, judgment is made of whether the surface condition of the optical disk 1 needs the learning operation or whether the current temperature has a temperature difference that needs the learning operation when compared to the temperature previously measured at the end of the past learning operation and stored in the memory 8. Here, since the learning operation is not necessary, the operating mode is continued even after the end of the judgment about the necessity of the learning operation. The digital data accumulated in the buffer memory 11 up to this time is sequentially recorded as recording data on the optical disk 1. Here, the rate of reading the accumulated data is higher than that of accumulating the data. Thus, the amount of data within the buffer memory 11 decreases. When the amount of data within the buffer memory 11 decreases down to the predetermined value v2 as shown by the waveform (b) of FIG. 4, the spindle motor control circuit 3, optical head control circuit 5, spindle motor 2 and optical head portion 4 are stopped in their operations so that the optical disk apparatus can be made in the standby mode. Thereafter, the intermittent operation is repeated as in the embodiment 1.

The operation of drive controller 7 in the case where the learning operation is necessary will be described with reference to the waveforms (c) and (d) of FIG. 4. In the stopped mode, when the user pushes the recording button 13, the recording start request is issued. Thus, the spindle motor control circuit 3 and optical head control circuit 5 are actuated to control the spindle motor 2 and optical head portion 4 so that the optical disk apparatus can be made in the operating mode, in which judgment is made of whether the learning operation is necessary. At this time, the optical head portion 4 irradiates a laser beam on the surface of the optical disk 1 to acquire the surface condition of the optical disk 1, and the temperature sensor 6 measures the current temperature to acquire the current temperature. From the acquired surface condition and current temperature, judgment is made of whether the surface condition of the optical disk 1 needs the learning operation or whether the acquired current temperature has a temperature difference that needs the learning operation when compared to the temperature previously measured at the end of the past learning operation and stored in the memory 8. Here, since the learning operation is necessary, the operating mode is continued and the learning operation is performed. Thereafter, when the learning operation is finished, the digital data so far accumulated within the buffer memory 11 is sequentially read out and recorded as the recording data on the optical disk 1. In this case, the rate of reading the data is higher than that of accumulating the data, the amount of the data accumulated within the buffer memory 11 decreases. When the amount of the data decreases down to the predetermined value v2 as shown by the waveform (d) of FIG. 4, the spindle motor control circuit 3, optical head control circuit 5, spindle motor 2 and optical head portion 4 are stopped from their operations so that the optical disk apparatus can be made in the standby mode. Thereafter, the intermittent operation is repeated as in the embodiment 1.

As described above, when the learning operation is not necessary, the digital data accumulated within the buffer memory 11 until the end of the judgment about the necessity of the learning operation is sequentially read and recorded as the recording data on the optical disk 1, and then the spindle motor control circuit 3, optical head control circuit 5, spindle motor 2 and optical head portion 4 are stopped from their operations. In addition, when the learning operation is necessary, the learning operation is performed. After the end of the learning operation, the digital data so far accumulated within the buffer memory 11 is read out and recorded as the recording data on the optical disk 1, and then the spindle motor control circuit 3, optical head control circuit 5, spindle motor 2 and optical head portion 4 are stopped from their operations. Therefore, the optical disk apparatus is not unnecessarily made in operating mode, and the standby mode can be extended until the amount of the digital data accumulated within the buffer memory 11 exceeds the predetermined value. Accordingly, unnecessary power can be prevented from being consumed, and thus the power consumption can be further reduced.

While the video signal from the camera circuit is recorded and reproduced in the above embodiment, the present invention is not limited to the above description, but can be applied to other recording and reproducing apparatus such as a video recorder by substituting, for example, a radio signal receiving circuit for the camera circuit.

### Embodiment 3

The embodiment 3 will be described below. The optical disk apparatus 17 and signal recording and reproducing apparatus 18 in the embodiment 3 are the same as in the embodiment 1, and the recording method using the intermittent operation is also the same as in the embodiment 1. However, in this embodiment, the judgment about the necessity of the learning operation is not performed by using the information of the condition of optical disk 1, but made by using only the information of the temperature change.

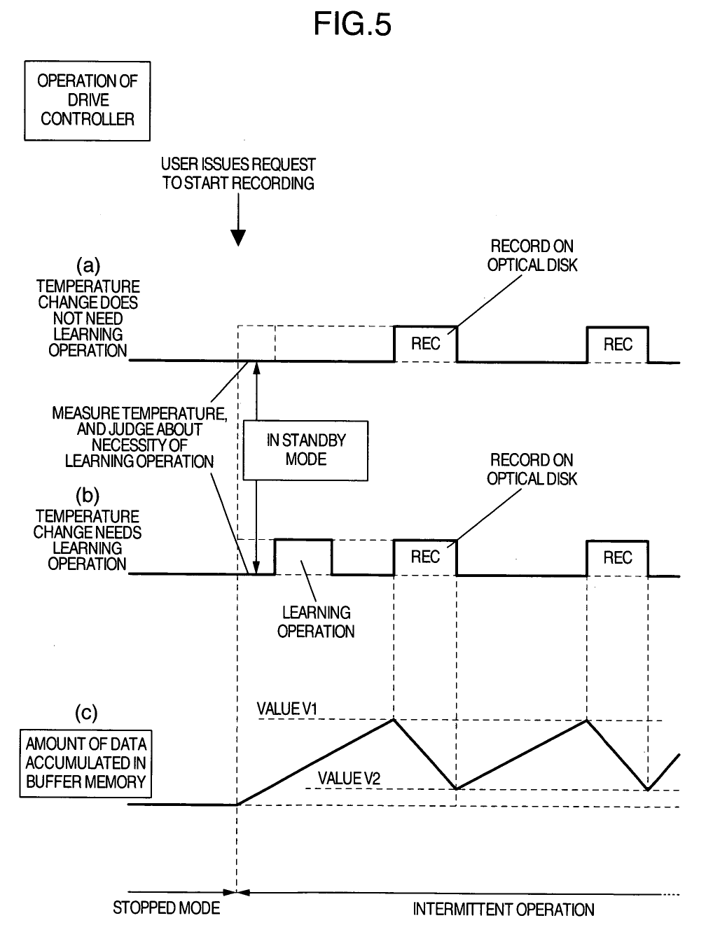

With reference to FIG. 5, description will be made of the details of the operation of drive controller 7 in the case where the optical disk apparatus 17 is shifted from the stopped mode to the intermittent operation when the user enters the recording start request. FIG. 5 is a timing chart of the operation of drive controller 7 in the third embodiment according to the invention. In FIG. 5, a waveform (a) shows the timing of the operation of drive controller 7 in the case where the learning operation is not necessary, a waveform (b) the timing of the operation of drive controller 7 in the case where the learning operation is necessary, and a waveform (c) the change of the amount of the digital data accumulated in the buffer memory 11.

The operation of drive controller 7 in the case where the learning operation is not necessary will be described with reference to the waveforms (a) and (c) of FIG. 5. In the stopped mode, when the user pushes the recording button 13 to enter the recording start request, the optical disk apparatus is transiently shifted to the intermittent operation and made in the standby mode, and at the same time the current temperature from the temperature sensor 6 is compared with the temperature previously measured at the end of the past learning operation and stored in the memory so that judgment can be made of whether the learning operation is necessary. Here, since the learning operation is not necessary, the operation of the spindle motor control circuit 3, optical head control circuit 5, spindle motor 2 and optical head portion 4 stays stopped so that the optical disk apparatus can be maintained in the standby mode. On the other hand, the amount of the digital data increases as a result of accumulation of data in the buffer memory 11 from when the recording start request is entered. When the amount exceeds the predetermined value v1 as shown by the waveform (c) of FIG. 5, the spindle motor control circuit 3 and optical head control circuit 5 are actuated to control the spindle motor 2 and optical head portion 4 so that the optical disk apparatus can be made in the operating mode. Thus, the digital data is sequentially read out from the buffer memory 11 and recorded as the recording data on the optical disk 1. Here, since the rate of reading out the data is higher than that of accumulating the data, the amount of the data accumulated in the buffer memory 11 decreases. When the amount decreases down to the predetermined value v2 as shown by the waveform (c) of FIG. 5, the spindle motor control circuit 3, optical head control circuit 5, spindle motor 2 and optical head portion 4 are stopped from their operations so that the optical disk apparatus can be made in the standby mode. Thereafter, the intermittent operation is repeated as in the embodiment 1.

The operation of drive controller 7 in the case where the learning operation is necessary will be described with reference to the waveforms (b) and (c) of FIG. 5. When the user pushes the recording button 13 in the stopped mode, the recording start request is entered so that the optical disk apparatus can be transiently shifted to the intermittent operation and made in the standby mode of the intermittent operation. At the same time, the current temperature from the temperature sensor 6 is compared with the temperature previously measured at the end of the past learning operation and stored in the memory 8 so that judgment can be made of whether the learning operation is necessary. Here, since the learning operation is necessary, the spindle motor control circuit 3 and optical head control circuit 5 are actuated to control the spindle motor 2 and optical head portion 4 after the end of the judgment about the necessity of the learning operation. Thus, the optical disk apparatus is made in the operating mode, in which the learning operation is performed. Then, after the learning operation is finished, the spindle motor control circuit 3, optical head control circuit 5, spindle motor 2 and optical head portion 4 are stopped from their operations so that the optical disk apparatus can be made in the standby mode. Thereafter, when the amount of the digital data accumulated in the buffer memory 11 increases to exceed the predetermined value v1 as shown by the waveform (c) of FIG. 5, the spindle motor control circuit 3 and optical head control circuit 5 are actuated to control the spindle motor 3 and optical head portion 4 so that the optical disk apparatus can be made in the operating mode. Thus, the digital data is sequentially read out from the buffer memory 11 and recorded as the recording data on the optical disk 1. Thereafter, the intermittent operation is repeated as in the embodiment 1.

As described above, when the learning operation is not necessary, the optical disk apparatus is shifted from the stopped mode to the standby mode so that the optical disk apparatus can be maintained at a condition of low power consumption. In addition, when the learning operation is necessary, the spindle motor control circuit 3 and optical head control circuit 5 are actuated to control the spindle motor 2 and optical head portion 4 immediately after judgment is made about the necessity of the learning operation when the apparatus is in the standby mode. Thus, the optical disk apparatus can be made in the operating mode, in which the learning operation is performed. After the end of the learning operation, the spindle motor control circuit 3, optical head control circuit 5, spindle motor 2 and optical head portion 4 are stopped from their operations. Therefore, the operating mode is not necessary for the judgment about the necessity of the learning operation, and the optical disk apparatus is maintained in the standby mode until the amount of the digital data accumulated in the buffer memory 11 exceeds the predetermined value v1. Accordingly, unnecessary power can be prevented from being consumed, and thus the power consumption can be further reduced.

It should be further understood by those skilled in the art that although the foregoing description has been made on embodiments of the invention, the invention is not limited thereto and various changes and modifications may be made without departing from the spirit of the invention and the scope of the appended claims.

1. An optical disk apparatus comprising:
a drive/control device which drives and controls a spindle motor and/or an optical head portion;
an intermittent operation unit which makes said drive/control device intermittently operate so that the recording can be made on an optical disk; and
a learning operation unit which judges about the necessity of a learning operation for obtaining a predetermined control value to said drive/control device under an arbitrary condition and which makes said learning operation on the basis of the result of said judgment, when a predetermined operation is made to start recording so that said optical disk apparatus is transiently shifted to said intermittent operation, said drive/control device is actuated so that said optical disk apparatus is made in an operating mode in which said judgment is made about the necessity of said learning operation, in which case, if said learning operation is judged not to be necessary, said drive/control device is stopped from its operation so that said optical disk apparatus can be shifted to a standby mode after the end of said judgment about the necessity of said learning operation.

2. An optical disk apparatus comprising:
a drive/control device which drives and controls a spindle motor and/or an optical head portion;
an intermittent operation unit which makes said drive/control device intermittently operate so that the recording can be made on an optical disk; and
a learning operation unit which judges about the necessity of a learning operation for obtaining a predetermined control value to said drive/control device under an arbitrary condition and which makes said learning operation on the basis of the result of said judgment, when a predetermined operation is made to start recording so that said optical disk apparatus is transiently shifted to said intermittent operation, said drive/control device is operated so that said optical disk apparatus can be made in an operating mode in which said judgment is made about the necessity of said learning operation, in which case, when said learning operation is judged to be necessary, said learning operation is performed, and then at the end of the learning operation said optical disk apparatus is shifted to a standby mode in which said drive/control device is stopped from its operation.

3. An optical disk apparatus comprising:
a recording/standby memory device which accumulates an audio signal and video signal to be recorded;
a signal processing circuit which processes said signal read from said recording/standby memory device so that it can be recorded on an optical disk;
a drive/control device which drives and controls a spindle motor and/or an optical head portion;
an intermittent operation unit which makes said drive/control device intermittently operate so that the recording can be made on said optical disk; and
a learning operation unit which judges about the necessity of a learning operation for obtaining a predetermined control value to said drive/control device under an arbitrary condition and which makes said learning operation on the basis of the result of said judgment, when a predetermined operation is made to start recording so that said optical disk apparatus is transiently shifted to said intermittent operation, said drive/control device is operated so that said optical disk apparatus can be made in an operating mode in which said judgment is made about the necessity of said learning operation, in which case, when said learning operation is judged not to be necessary, said signal to be recorded that has been accumulated in said recording/standby memory until the end of said judgment about the necessity of said learning operation is recorded on said optical disk, and then said optical disk apparatus is shifted to a standby mode in which said drive/control device is stopped from its operation.

4. An optical disk apparatus comprising:
a recording/standby memory device which accumulates an audio signal and video signal to be recorded;
a signal processing circuit which processes said signal read from said recording/standby memory device so that it can be recorded on an optical disk;
a drive/control device which drives and controls a spindle motor and/or an optical head portion;
an intermittent operation unit which makes said drive/control device intermittently operate so that the recording can be made on said optical disk; and
a learning operation unit which judges about the necessity of a learning operation for obtaining a predetermined control value to said drive/control means under an arbitrary condition and which makes said learning operation on the basis of the result of said judgment, when a predetermined operation is made to start recording so that said optical disk apparatus is transiently shifted to said intermittent operation, said drive/control device is immediately operated so that said optical disk apparatus can be made in an operating mode in which said judgment is made about the necessity of said learning operation, in which case, if said learning operation is judged to be necessary, said signal accumulated in said recording/standby memory device until the end of said learning operation is recorded on said optical disk, and then said optical disk apparatus is shifted to a standby mode in which said drive/control means is stopped from its operation.

5. An optical disk apparatus comprising:
a drive/control device which drives and controls a spindle motor and/or an optical head portion;
an intermittent operation unit which makes said drive/control device intermittently operate so that the recording can be made on an optical disk; and
a learning operation unit which judges about the necessity of a learning operation for obtaining a predetermined control value to said drive/control device under a temperature change and which makes said learning operation on the basis of the result of said judgment, when a predetermined operation is made to start recording so that said optical disk apparatus can be transiently shifted to said intermittent operation, said drive/control device is stopped in its operation so that said apparatus can be shifted to a standby mode, and at this time said judgment is made of whether said learning operation is necessary on the basis of information of said temperature change, in which case, when said learning operation is judged not to be necessary, said standby mode is maintained.

6. An optical disk apparatus comprising:
a drive/control device which drives and controls a spindle motor and/or an optical head portion;
an intermittent operation unit which makes said drive/control device intermittently operate so that the recording can be made on an optical disk; and
a learning operation unit which judges about the necessity of a learning operation for obtaining a predetermined control value to said drive/control device under a temperature change and which makes said learning operation on the basis of the result of said judgment, when a predetermined operation is made to start recording so that said optical disk apparatus is transiently shifted to said intermittent operation, said drive/control device is stopped in its operation so that said optical disk apparatus can be shifted to a standby mode, and at this time said judgment is made of whether said learning operation is necessary on the basis of information of said temperature change, in which case, if said learning operation is judged to be necessary, said drive/control device is actuated so that said optical disk apparatus can be made in an operation mode in which said learning operation is performed, and said drive/control device is stopped in its operation after the end of said learning operation so that said optical disk apparatus can be shifted to said standby mode.
